(19) United States
(12) Patent Application Publication
(10) Pub. No.: US 2024/0004913 A1
(43) Pub. Date: Jan. 4, 2024

(54) LONG TEXT CLUSTERING METHOD BASED ON INTRODUCING EXTERNAL LABEL INFORMATION

(71) Applicant: International Business Machines Corporation, Armonk, NY (US)

(72) Inventors: Zhong Fang Yuan, Xi'an (CN); Tong Liu, Xi'an (CN); Wen Wang, Beijing (CN); Li Juan Gao, Xi'an (CN); Xiang Yu Yang, Xi'an (CN)

(21) Appl. No.: 17/809,624

(22) Filed: Jun. 29, 2022

(51) Int. Cl. G06F 16/35

(52) U.S. Cl. CPC G06F 16/353

(57) ABSTRACT

In an approach for using an open source of existing text labeling models to label sentences that need to be clustered with multiple external tags and then to use the tags as auxiliary information to perform the clustering at a dual level, a processor receives a set of text, wherein the set of text contains one or more sentences. A processor tags each sentence of the set of text with one or more tags using a plurality of open-source text classification models. A processor performs a preliminary clustering of one or more nodes under strict conditions using a canopy clustering algorithm.

### BACKGROUND OF THE INVENTION

The present invention relates generally to the field of data processing, and more particularly to a long text clustering method based on introducing external label information.

Text clustering is the process of dividing a set of unlabeled text into clusters based on one or more similarities. In other words, the set of unlabeled text is divided in such a way that the text contained in one cluster is more similar to the other text in the cluster than to the text in other clusters. Typically, a language vector model, such as word2vec, Bidirectional Encoder Representations (BERT), and Generative Pre-Training (GPT), vectorizes the set of unlabeled text. The similarities in the set of unlabeled text are identified by measuring the distance between the vectors. Vectors that are near each other are placed in the same cluster, whereas vectors that are further away from each other are placed in different clusters. A text clustering algorithm, such as K-means and density-based spatial clustering (DBSCAN), then processes the vectors and detects whether any natural clusters exist. A criterion function analyzes the clusters detected and determines whether the best possible clusters have been found. When the best possible clusters have been found, the criterion function stops any further processing by the text clustering algorithm. A greedy algorithm may be used to optimize the criterion function. The greedy algorithm starts with some initial clustering and then refines the clusters iteratively. Each cluster is assigned a descriptive name, a relevance value (i.e., a value indicative of the relative importance of the cluster with respect to all the clusters), its size, and the list of elements that are included in the cluster.

Text clustering is used for many different tasks. For example, text clustering is used for document retrieval. To improve recall, text clustering algorithms group similar documents (e.g., news stories, emails, messages, tweets, etc.) into the same cluster. In another example, text clustering is used for customer support issue analysis. To improve customer support, text clustering algorithms identify commonly reported support issues and group the similar support issues into the same cluster.

Text clustering has been the subject of a plurality of patents. For example, in U.S. Pat. No. 9,183,193 B2 entitled Bag-of-Repeats Representation of Documents, “a system and method for representing a textual document based on the occurrence of repeats” is disclosed. The system and method disclosed “includes a sequence generator which defines a sequence representing words forming a collection of documents. A repeat calculator identifies a set of repeats within the sequence, the set of repeats comprising subsequences of the sequence which each occur more than once. A representation generator generates a representation for at least one document in the collection of documents based on occurrence, in the document, of repeats from the set of repeats.” This system and method differs from the system and method of the present invention in that the system and method of the present invention uses subsequences to characterize documents, and then uses this characterization for text clustering. The system and method of the present invention also uses external model tags for long text representation.

In Patent CN101079026-B entitled Text Similarity, Acceptation Similarity Calculating Method and System and Application System, a system and method to calculate the degree of text similarity and the degree of vocabulary meaning similarity is disclosed. This system and method differs from the system and method of the present invention in that the search conducted in this system and method uses semantic similarity to do long text clustering. Further, the system and method of the present invention uses open-source models to introduce external knowledge, which is fundamentally different from what the system and method of the present invention does.

In Patent CN112836043-A entitled Long Text Clustering Method and Device Based on Pre-Training Language Model, “a long text clustering method and a device based on a pre-training language model” is disclosed. The long text clustering method involves “compressing the long text into a short text by using a text abstract model”; “predicting whether the two texts contain the same event or not according to the short text obtained in the” compressing step “and the labeled text sentence pair of the BERT model”; “generating an initial score of the text pair”; “recalculating the score according to the relationship of the text pair with other texts by using the text pair initial score obtained in the” predicting step as an initial score; and calculating the groupings “starting with the highest scoring text pair based on the text pair scores obtained in” the recalculating step. The system and method “applies a deep learning method and adopts transfer learning to apply a large-scale pre-training model to text clustering.” The system and method of the present invention proposes a long text clustering method based on a pre-trained language model and external label information to solve the problem of “collapse” in long-text clustering. This system and method and the system and method of the present invention focus on improving the accuracy of long-text clustering and use a pre-trained language model. However, this system and method and the system and method of the present invention are different. This system and method compresses the long text into short text, whereas the system and method of the present invention introduces external label information.

The present invention recognizes that a solution to the “collapse” phenomenon of representation has not been addressed in the plurality of patents mentioned. To further explain the “collapse” phenomenon of representation, a sentence vector is a linear aggregation of word vectors corresponding to the words in a sentence. When a set of text contains too many words, the sentence vectors are encoded into a smaller spatial region. This causes most sentence pairs to have high similarity score, even if the words in the sentence are semantically unrelated. This is the “collapse” phenomenon of representation. The reason the “collapse” phenomenon occurs is because the sentence vector representation method, which is based on semantic vectors, has not undergone “difference” marking training, which leads to its tendency to coalesce. Having the sentence vectors encoded into a smaller spatial region also causes poor performance of long text clustering scenes. Therefore, embodiments of the present invention recognize the need for a system and method to prevent the “collapse” phenomenon caused by pure semantic vector clustering from occurring in long text clustering scenes.

### SUMMARY

Aspects of an embodiment of the present invention disclose a method, computer program product, and computer system for using an open source of existing text labeling models to label the sentences that need to be clustered with multiple external tags and then to use the tags as auxiliary information to perform the clustering at a dual level. A processor receives a set of text, wherein the set of text contains one or more sentences. A processor tags each sentence of the set of text with one or more tags using a plurality of open-source text classification models. A processor performs a preliminary clustering of one or more nodes under strict conditions using a canopy clustering algorithm.

In some aspects of an embodiment of the present invention, a processor divides each sentence of the set of text into one or more categories, wherein each category of the one or more categories represents a grouping regarded as having a particular shared characteristic.

In some aspects of an embodiment of the present invention, subsequent to tagging each sentence of the set of text with the one or more tags using the plurality of open-source text classification models, a processor filters the one or more tags using a confidence score. A processor retains each tag of the one or more tags with a confidence score greater than 0.5. A processor removes each tag of the one or more tags with a confidence score less than 0.5.

In some aspects of an embodiment of the present invention, subsequent to filtering the one or more tags using the confidence score, a processor represents each sentence of the set of text as a first node in a graph structure. A processor represents each tag of the one or more tags as an attribute of the first node in the graph structure.

In some aspects of an embodiment of the present invention, subsequent to representing each tag of the one or more tags as an attribute of the first node in the graph structure, a processor embeds each sentence and each tag of the first node using a one-hot encoding method. A processor vectorizes each sentence and each tag of the first node.

In some aspects of an embodiment of the present invention, a processor enables a part of the one or more nodes to organize to form a settlement.

In some aspects of an embodiment of the present invention, a processor determines the first node is a subordinate of a cluster using an algorithm. A processor organizes the first node into a miniature graph. A processor calculates a degree of similarity between the miniature graph and a second node. A processor assigns a clustering relationship to the miniature graph and the second node using link prediction.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a block diagram illustrating a distributed data processing environment, in accordance with an embodiment of the present invention;

FIG. 2 is a flowchart illustrating the operational steps of a long text clustering program, on a server within the distributed data processing environment of FIG. 1, in accordance with an embodiment of the present invention;

FIG. 3A is an exemplary diagram illustrating a filtering of tags of a plurality of external classification models, on the server within the distributed data processing environment of FIG. 1, in accordance with an embodiment of the present invention;

FIG. 3B is an exemplary diagram illustrating a forming of a node in a graph structure, on the server within the distributed data processing environment of FIG. 1, in accordance with an embodiment of the present invention;

FIG. 3C is an exemplary diagram illustrating a creation of a cluster, on the server within the distributed data processing environment of FIG. 1, in accordance with an embodiment of the present invention;

FIG. 3D is an exemplary diagram illustrating an aggregation of a plurality of clusters into a plurality of similar categories, on the server within the distributed data processing environment of FIG. 1, in accordance with an embodiment of the present invention;

FIG. 3E is an exemplary diagram illustrating an embedding of each sentence of the set of text and the tags associated with each sentence of the set of text, on the server within the distributed data processing environment of FIG. 1, in accordance with an embodiment of the present invention;

FIG. 3F is an exemplary diagram illustrating a preliminary clustering of one or more nodes, on the server within the distributed data processing environment of FIG. 1, in accordance with an embodiment of the present invention;

FIG. 3G is an exemplary diagram illustrating a determination of subordinates of similar clusters, on the server within the distributed data processing environment of FIG. 1, in accordance with an embodiment of the present invention;

FIG. 3H is an exemplary diagram illustrating an assignment of a clustering relationship using link prediction, on the server within the distributed data processing environment of FIG. 1, in accordance with an embodiment of the present invention; and

FIG. 4 is a block diagram illustrating the components of a computing device within the distributed data processing environment of FIG. 1, in accordance with an embodiment of the present invention.

### DETAILED DESCRIPTION

Embodiments of the present invention recognize that text clustering is the process of dividing a set of unlabeled text into clusters based on similarities. In other words, the set of unlabeled text is divided in such a way that the text contained in one cluster is more similar to the other text in the cluster than to the text in other clusters. Typically, a language vector model, such as word2vec, Bidirectional Encoder Representations (BERT), and Generative Pre-Training (GPT), vectorizes the set of unlabeled text. The similarities in the set of unlabeled text are identified by measuring the distance between the vectors. Vectors that are near each other are placed in the same cluster, whereas vectors that are further away from each other are placed in different clusters. A text clustering algorithm, such as K-means and density-based spatial clustering (DB SCAN), then processes the vectors and detects whether any natural clusters exist. A criterion function analyzes the clusters detected and determines whether the best possible clusters have been found. When the best possible clusters have been found, the criterion function stops any further processing by the text clustering algorithm. A greedy algorithm may be used to optimize the criterion function. The greedy algorithm starts with some initial clustering and then refines the clusters iteratively. Each cluster is assigned a descriptive name, a relevance value (i.e., a value indicative of the relative importance of the cluster with respect to all of the clusters), its size, and the list of elements that are included in the cluster.

Embodiments of the present invention recognize that text clustering is used for many different tasks. For example, text clustering is used for document retrieval. To improve recall, text clustering algorithms group similar documents (e.g., news stories, emails, messages, tweets, etc.) into the same cluster. In another example, text clustering is used for customer support issue analysis. To improve customer support, text clustering algorithms identify commonly reported support issues and group the similar support issues into the same cluster.

Embodiments of the present invention recognize that this process has multiple disadvantages. One disadvantage is referred to as the “collapse” phenomenon of representation. A sentence vector is a linear aggregation of word vectors corresponding to the words in a sentence. When a set of text contains too many words, the sentence vectors are encoded into a smaller spatial region. This causes most sentence pairs to have high similarity score, even if the words in the sentence are semantically unrelated. This is the “collapse” phenomenon of representation. The reason the “collapse” phenomenon occurs is because the sentence vector representation method, which is based on semantic vectors, has not undergone “difference” marking training, which leads to its tendency to coalesce. Having the sentence vectors encoded into a smaller spatial region also causes poor performance of long text clustering scenes. Therefore, embodiments of the present invention recognize the need for a system and method to prevent the “collapse” phenomenon caused by pure semantic vector clustering from occurring in long text clustering scenes.

Embodiments of the present invention provide a long text clustering method that is based on the introduction of external tag information. The long text clustering method uses an open source of existing text labeling models, which may or may not be semantically relevant to a text clustering scene, to label the sentences that need to be clustered with multiple external labels (hereinafter referred to as “tags”). The long text clustering method then uses the tags as auxiliary information to perform clustering at a dual level (i.e., tags and original semantics).

The long text clustering method proposed has three advantages. First, the text labeling models from the open source of existing text labeling models can be regarded as third-party experts. As experts, the text labeling models tag the target sentence from a professional perspective. The description of the target sentence and the related information can be used to make a “discriminatory judgment” for the template sentences in the clustering task. Second, the long text clustering method can be used to show clusters divided into different “labelled perspectives” because the clustering results may be different from different scenes and from different perspectives. In the traditional clustering results, the clustering results at the semantically similar level can be displayed statically. The clustering results cannot be displayed dynamically, i.e., according to different needs and perspectives. Third, the graph structure-based method used can optimize the clustering algorithm by leading to a stronger interpretation. Thus, the graph, which is a data structure, and the vector learned from using the graph will contain the information of neighboring nodes. This structural feature addresses the exploratory phenomena.

Implementation of embodiments of the present invention may take a variety of forms, and exemplary implementation details are discussed subsequently with reference to the Figures.

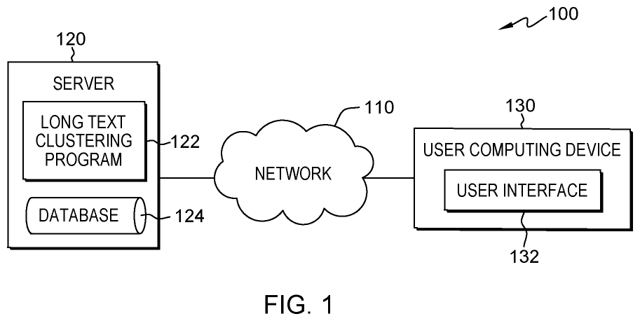

FIG. 1 is a block diagram illustrating a distributed data processing environment, generally designated 100, in accordance with an embodiment of the present invention. In the depicted embodiment, distributed data processing environment 100 includes server 120 and user computing device 130, interconnected over network 110. Distributed data processing environment 100 may include additional servers, computers, computing devices, and other devices not shown. The term “distributed” as used herein describes a computer system that includes multiple, physically distinct devices that operate together as a single computer system. FIG. 1 provides only an illustration of one embodiment of the present invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120, user computing device 130, and other computing devices (not shown) within distributed data processing environment 100.

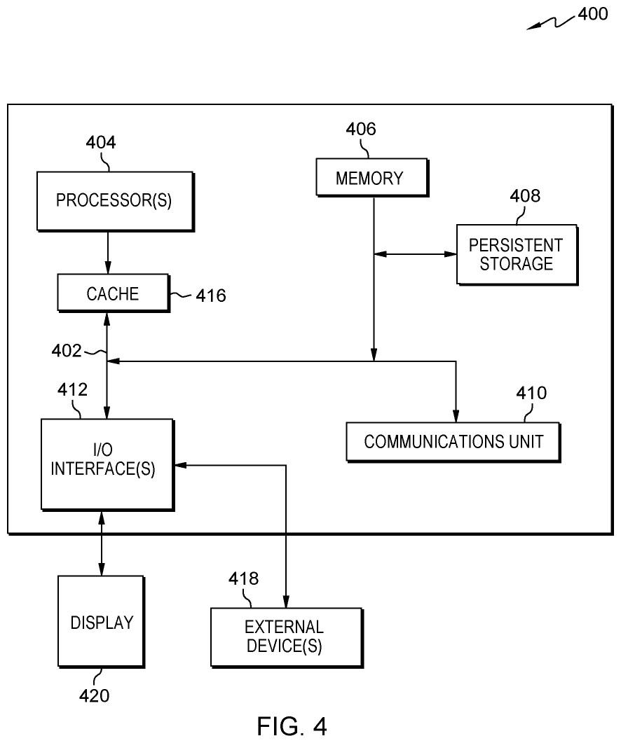

Server 120 operates to run long text clustering program 122 and to send and/or store data in database 124. In an embodiment, server 120 can send data from database 124 to user computing device 130. In an embodiment, server 120 can receive data in database 124 from user computing device 130. In one or more embodiments, server 120 can be a standalone computing device, a management server, a web server, a mobile computing device, or any other electronic device or computing system capable of receiving, sending, and processing data and capable of communicating with user computing device 130 via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing device 130 and other computing devices (not shown) within distributed data processing environment 100 via network 110. Server 120 may include internal and external hardware components, as depicted and described in further detail in FIG. 4.

Long text clustering program 122 operates to provide a long text clustering method, wherein the long text clustering method uses an open source of existing text labeling models to label the sentences that need to be clustered with multiple external tags and then to use the tags as auxiliary information to perform clustering at a dual level (i.e., tags and original semantics). In the depicted embodiment, long text clustering program 122 is a standalone program. In another embodiment, long text clustering program 122 may be integrated into another software product, such as a text clustering software, text mining software, text annotation software, information extraction software, and information audit software. In the depicted embodiment, long text clustering program 122 resides on server 120. In another embodiment, long text clustering program 122 may reside on user computing device 130 or on another computing device (not shown), provided that long text clustering program 122 has access to network 110.

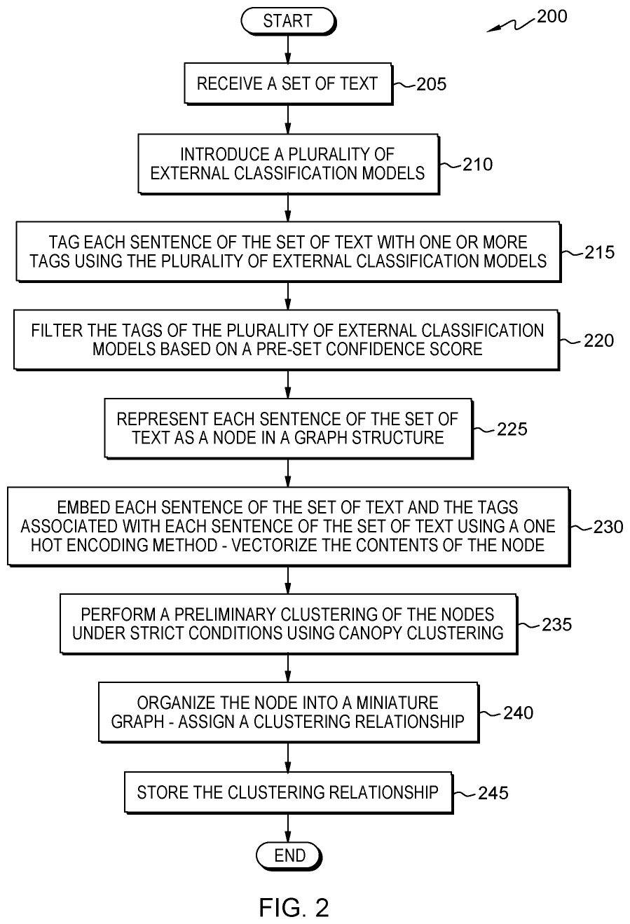

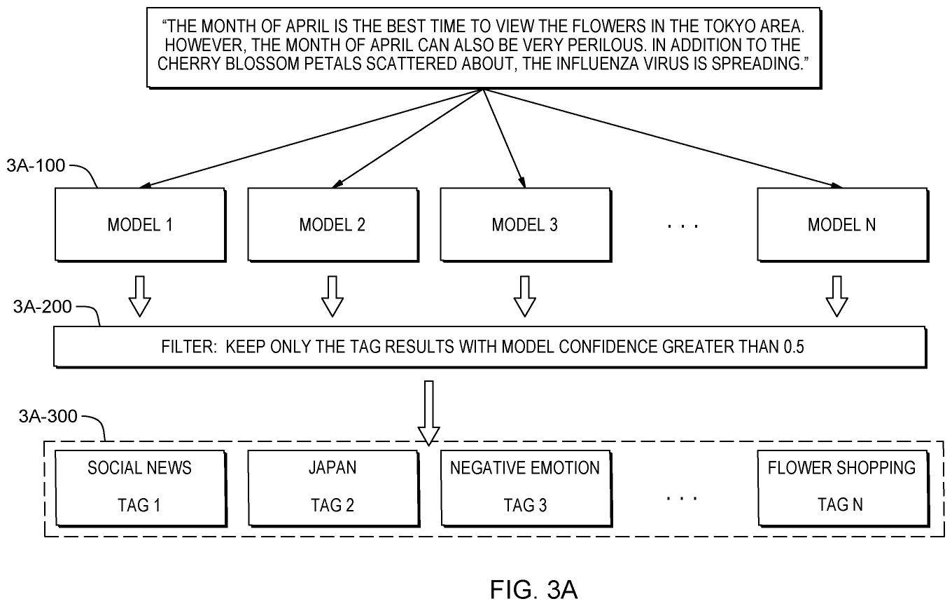

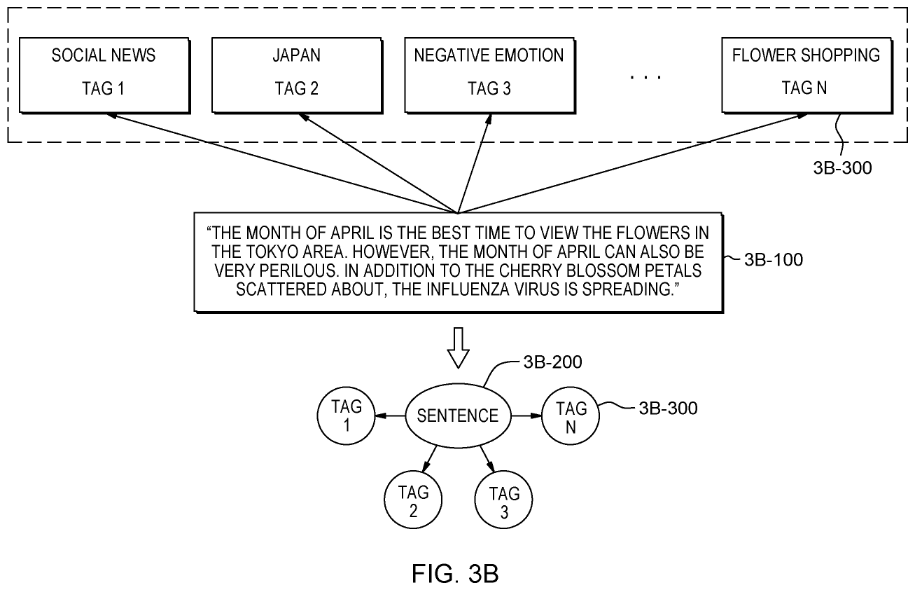

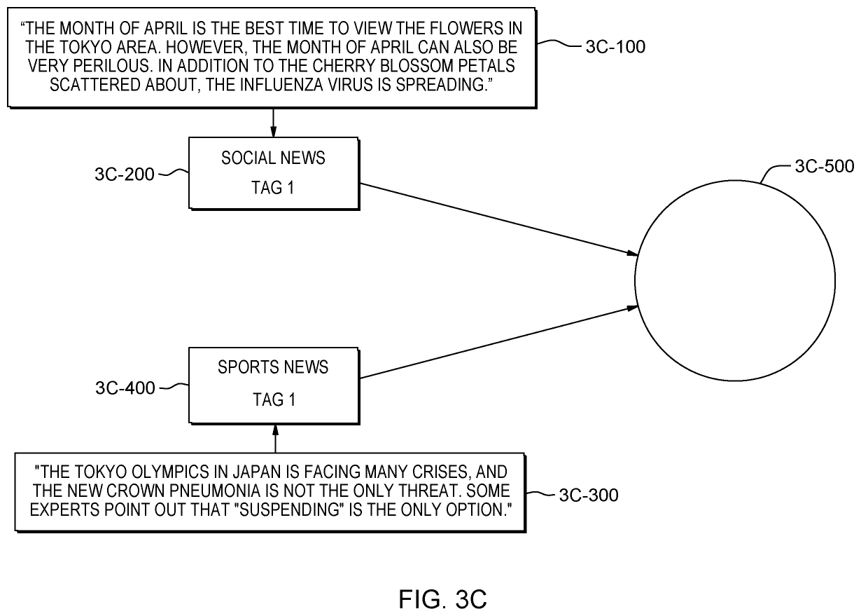

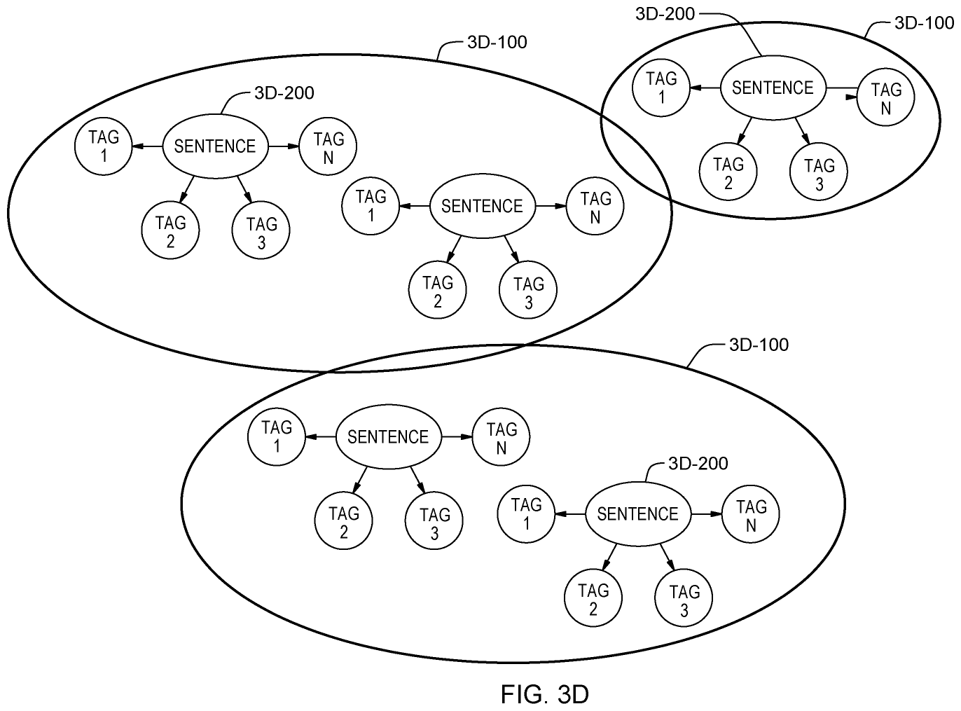

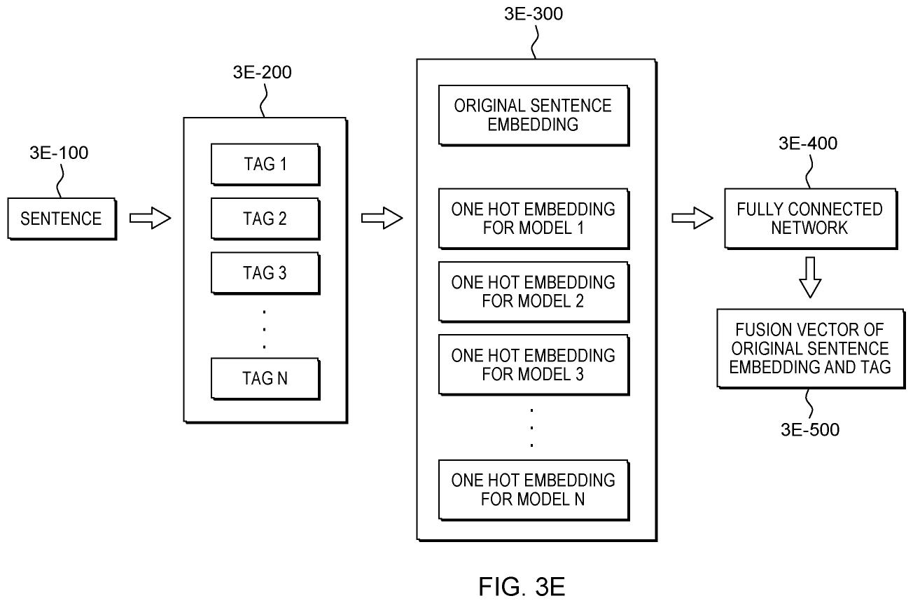

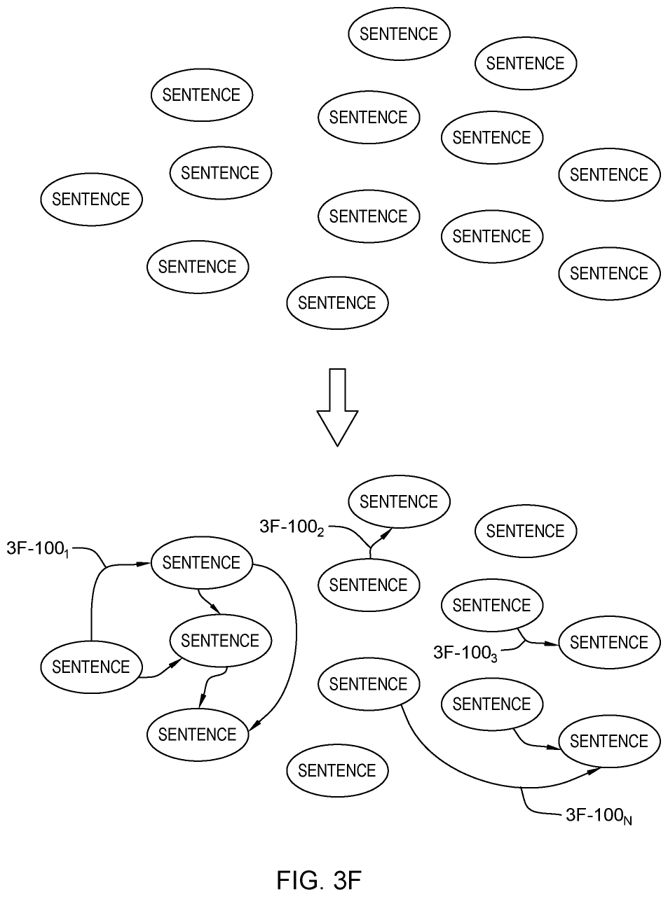

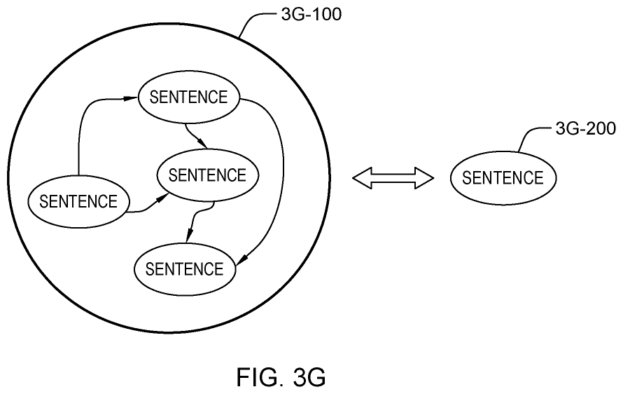

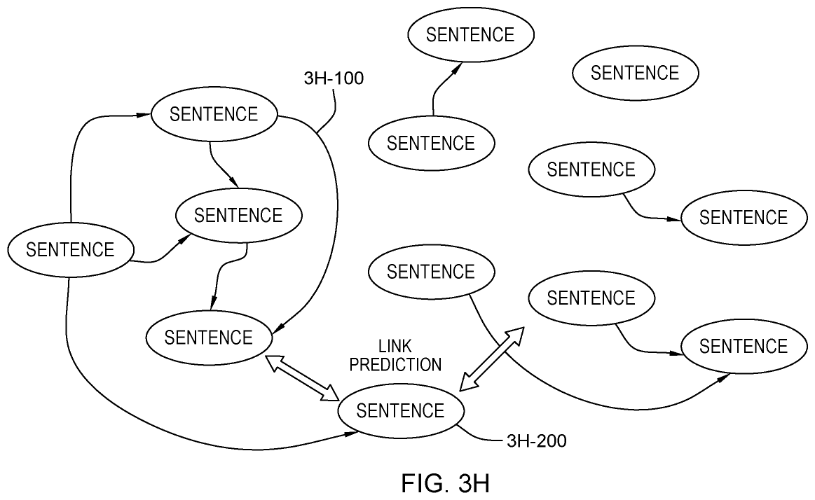

In an embodiment, the user of user computing device 130 registers with server 120. For example, the user completes a registration process (e.g., user validation), provides information to create a user profile, and authorizes the collection, analysis, and distribution (i.e., opts-in) of relevant data on identified computing devices (e.g., on user computing device 130) by server 120 (e.g., via long text clustering program 122). Relevant data includes, but is not limited to, personal information or data provided by the user or inadvertently provided by the user's device without the user's knowledge; tagged and/or recorded location information of the user (e.g., to infer context (i.e., time, place, and usage) of a location or existence); time stamped temporal information (e.g., to infer contextual reference points); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 124. The operational steps of long text clustering program 122 are depicted and described in further detail with respect to FIG. 2. An exemplary diagram illustrating a filtering of tags of a plurality of external classification models is depicted and described in FIG. 3A. An exemplary diagram illustrating a forming of a node in a graph structure is depicted and described in FIG. 3B. An exemplary diagram illustrating a creation of a cluster is depicted and described in FIG. 3C. An exemplary diagram illustrating an aggregation of a plurality of clusters into a plurality of similar categories is depicted and described in FIG. 3D. An exemplary diagram illustrating an embedding of each sentence of the set of text and the tags associated with each sentence of the set of text is depicted and described in FIG. 3E. An exemplary diagram illustrating a preliminary clustering of one or more nodes is depicted and described in FIG. 3F. An exemplary diagram illustrating a determination of subordinates of similar clusters is depicted and described in FIG. 3G. An exemplary diagram illustrating an assignment of a clustering relationship using link prediction is depicted and described in FIG. 3H.

Database 124 operates as a repository for data received, used, and/or generated by long text clustering program 122. A database is an organized collection of data. Data includes, but is not limited to, information about user preferences (e.g., general user system settings such as alert notifications for user computing device 130); information about alert notification preferences; a set of text received; a clustering relationship assigned; and any other data received, used, and/or generated by long text clustering program 122.

Database 124 can be implemented with any type of device capable of storing data and configuration files that can be accessed and utilized by server 120, such as a hard disk drive, a database server, or a flash memory. In an embodiment, database 124 is accessed by long text clustering program 122 to store and/or to access the data. In the depicted embodiment, database 124 resides on server 120. In another embodiment, database 124 may reside on another computing device, server, cloud server, or spread across multiple devices elsewhere (not shown) within distributed data processing environment 100, provided that long text clustering program 122 has access to database 124.

The present invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Long text clustering program 122 enables the authorized and secure processing of personal data.

Long text clustering program 122 provides informed consent, with notice of the collection of personal and/or confidential data, allowing the user to opt-in or opt-out of processing personal and/or confidential data. Consent can take several forms. Opt-in consent can impose on the user to take an affirmative action before personal and/or confidential data is processed. Alternatively, opt-out consent can impose on the user to take an affirmative action to prevent the processing of personal and/or confidential data before personal and/or confidential data is processed. Long text clustering program 122 provides information regarding personal and/or confidential data and the nature (e.g., type, scope, purpose, duration, etc.) of the processing. Long text clustering program 122 provides the user with copies of stored personal and/or confidential company data. Long text clustering program 122 allows the correction or completion of incorrect or incomplete personal and/or confidential data. Long text clustering program 122 allows for the immediate deletion of personal and/or confidential data.

User computing device 130 operates to run user interface 132 through which a user can interact with long text clustering program 122 on server 120. In an embodiment, user computing device 130 is a device that performs programmable instructions. For example, user computing device 130 may be an electronic device, such as a laptop computer, a tablet computer, a netbook computer, a personal computer, a desktop computer, a smart phone, or any programmable electronic device capable of running user interface 132 and of communicating (i.e., sending and receiving data) with long text clustering program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 includes an instance of user interface 132. User computing device 130 may include components as described in further detail in FIG. 4.

User interface 132 operates as a local user interface between long text clustering program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from long text clustering program 122 to a user via network 110. User interface 132 can also display or present alerts including information (such as graphics, text, and/or sound) sent from long text clustering program 122 to a user via network 110. In an embodiment, user interface 132 is capable of sending and receiving data (i.e., to and from long text clustering program 122 via network 110, respectively). Through user interface 132, a user can opt-in to long text clustering program 122; create a user profile; set user preferences and alert notification preferences; and input a set of text.

A user preference is a setting that can be customized for a particular user. A set of default user preferences are assigned to each user of long text clustering program 122. A user preference editor can be used to update values to change the default user preferences. User preferences that can be customized include, but are not limited to, general user system settings, specific user profile settings, alert notification settings, and machine-learned data collection/storage settings. Machine-learned data is a user's personalized corpus of data. Machine-learned data includes, but is not limited to, past results of iterations of long text clustering program 122.

FIG. 2 is a flowchart, generally designated 200, illustrating the operational steps of long text clustering program 122, on server 120 within distributed data processing environment 100 of FIG. 1, in accordance with an embodiment of the present invention. In an embodiment, long text clustering program 122 operates to provide a long text clustering method, wherein the long text clustering method uses an open source of existing text labeling models to label the sentences that need to be clustered with multiple external tags and then uses the tags as auxiliary information to perform clustering at a dual level (i.e., tags and original semantics). It should be appreciated that the process depicted in FIG. 2 illustrates one possible iteration of the process flow, which may be repeated each time a set of text containing one or more sentences is received by long text clustering program 122.

In step 205, long text clustering program 122 (hereinafter referred to as “program 122”) receives a set of text. The set of text contains one or more sentences. In an embodiment, program 122 receives a set of text from a user inputted in a user computing device (e.g., user computing device 130) via a user interface (e.g., user interface 132). In another embodiment, program 122 retrieves a set of text from a database (e.g., database 124). In another embodiment, program 122 retrieves a set of text from an external source (e.g., from the internet).

In step 210, program 122 introduces a plurality of open-source text classification models (hereinafter referred to as “the plurality of external classification models”). In an embodiment, responsive to receiving the set of text, program 122 introduces the plurality of external classification models. Each external classification model has been trained on external data from a particular field. Therefore, each external classification model may be regarded as a third-party expert in the particular field in which each external classification model has been trained. Further, each external classification model represents a different perspective of evaluating the set of text. The perspective from which the external classification model evaluates the set of text is based on the particular field in which each external classification model has been trained. The perspective from which the external classification model evaluates the set of text may be used as a reference for measuring the difference in the set of text. The plurality of external classification models may include, but are not limited to, an IMDB sentiment classification model, a news classification model, and a story classification model.

In step 215, program 122 divides each sentence of the set of text into one or more categories. In an embodiment, responsive to introducing the plurality of external classification models, program 122 divides each sentence of the set of text into one or more categories. Each category represents a grouping regarded as having a particular shared characteristic (i.e., a common topic). In an embodiment, program 122 tags each sentence of the set of text (i.e., each category of the one or more categories) with one or more tags using the plurality of external classification models. In an embodiment, program 122 generates a two-tuple. The two-tuple is composed of a category and a confidence score. The category refers to the category into which each sentence to be classified is classified. The confidence score refers to a probability that each sentence to be classified is considered to be a certain category.

For example, program 122 receives a first set of text from a user inputted in user computing device 130 via user interface 132. The first set of text, designated Sentence A, reads, “The month of April is the best time to view the flowers in the Tokyo area. However, the month of April can able be very perilous. In addition to the cherry blossom petals scattered about, the influenza virus is spreading.” Program 122 categorizes Sentence A as “news” and tags Sentence A as “social news.” Program 122 also receives a second set of text from the user inputted in user computing device 130 via user interface 132. The second set of text, designated Sentence B, reads, “The Tokyo Olympics in Japan is facing many crises, and the new crown pneumonia is not the only threat. Some experts point out that “suspending” is the only option.” Sentence B is very similar to Sentence A based on semantics. Program 122 categorizes Sentence B as “news,” but labels Sentence B as “sports news” or “international news” to give it a certain degree of difference in the following clustering steps.

In step 220, program 122 filters the tags of the plurality of external classification models. In an embodiment, responsive to dividing each sentence of the set of text into one or more categories, program 122 filters the tags of the plurality of external classification models. In an embodiment, program 122 filters the tags of the plurality of external classification models based on a pre-set confidence score (i.e., a pre-set threshold based on a deep learning model, e.g., as shown in FIG. 3A). In an embodiment, program 122 filters the tags of the plurality of external classification models to remove any tags that are irrelevant to the one or more sentences of the set of text. In other words, program 122 filters the tags of the plurality of external classification models to ensure the tags are related to the meaning of the one or more sentences of the set of text. A tag is determined to be irrelevant to the one or more sentences of the set of text when the tag provided by the external classification model does not exceed a confidence score of 0.5. In an embodiment, program 122 retains the tags with a confidence score greater than 0.5 and any associated tags. In an embodiment, program 122 removes the tags with a confidence score less than 0.5 and the associated tags.

In step 225, program 122 represents each sentence of the set of text as a node in a graph structure. In an embodiment, responsive to filtering the tags of the plurality of external classification models, program 122 represents each sentence of the set of text as a node in a graph structure. In an embodiment, program 122 represents each of the tags associated with each sentence of the set of text as attributes of the node in the graph structure (e.g., as shown in FIGS. 3B and 3E). Each sentence of the set of text may be regarded as an ontology. Each of the tags associated with each sentence of the set of text may be regarded as attributes. In an embodiment, program 122 generates an information set. The information set includes the ontology and the attributes. The information set is used as input for the following step, step 230.

In step 230, program 122 embeds each sentence of the set of text and the tags associated with each sentence of the set of text. In an embodiment, responsive to representing each sentence of the set of text as a node in the graph structure, program 122 embeds each sentence of the set of text and the tags associated with each sentence of the set of text. In an embodiment, program 122 embeds each sentence of the set of text and the tags associated with each sentence of the set of text using a one hot encoding method (e.g., as shown in FIG. 3E). In an embodiment, program 122 vectorizes the contents of the node (i.e., the sentence and the tags associated with the sentence).

In vector semantics, a word is modeled as a vector—a point in a multidimensional semantic space that is derived from the distribution of word neighbors. The vectors representing the words are also called embeddings. The word “embedding” derives from its mathematical sense as a mapping from one space or structure to another.

Word embedding is a term used in Natural Language Processing (NLP) for the learned representation of words for text analysis, typically in the form of a real-valued vector that encodes the meaning of the word such that the words that are closer in the vector space are similar in meaning and context. Word embeddings can be obtained using a set of language modeling and feature learning techniques where words or phrases from the vocabulary are mapped to vectors of real numbers.

One hot encoding is a method used to perform the task of word embedding. One hot encoding is the process of transforming categorical integer features into “one-hot” vectors. In relational terms, this transformation results in added columns (i.e., one column for each distinct category) and the assignment of a 1 or a 0 (i.e., true or false, respectively) to each feature of a sample, wherein the assignment of a 1 or a 0 represents whether the feature corresponds to its original category.

In NLP, a one-hot vector is a 1×N matrix (i.e., a vector) used to distinguish each word in a vocabulary from every other word in the vocabulary. The vector consists of Os in all cells with the exception of a single 1 in a cell used uniquely to identify the word. One-hot encoding ensures that machine learning does not assume that higher numbers are more important. For example, the value ‘8’ is bigger than the value ‘1,’ but that does not make ‘8’ more important than ‘1.’ The same is true for words: the value of ‘laughter’ is not more important than ‘laugh.’

In machine learning, one-hot encoding is a frequently used method to deal with categorical data. Because many machine learning models need their input variables to be numeric, categorical variables need to be transformed during the pre-processing part. Categorical variables can be either nominal or ordinal. Ordinal data has a ranked order for its values and therefore can be converted to numerical data through ordinal encoding. An example of ordinal data is the ratings on a test ranging from A to F, which can be ranked using numbers from 6 to 1. Since there is no quantitative relationship between nominal variables' individual values, using ordinal encoding can potentially create a fictional ordinal relationship in the data. Therefore, one-hot encoding is often applied to nominal variables to improve the performance of the algorithm. In this method, for each unique value in the original categorical column, a new column is created. These columns are then filled up with a 1 or a 0 (i.e., true or false).

In step 235, program 122 performs a preliminary clustering of the nodes. In an embodiment, responsive to embedding each sentence of the set of text and the tags associated with each sentence of the set of text, program 122 performs a preliminary clustering of the nodes. In an embodiment, program 122 performs a preliminary clustering of the nodes under strict conditions using canopy clustering (e.g., as shown in FIG. 3F). In an embodiment, program 122 enables a small part of the overall node to organize each other to form a settlement (i.e., a fusion of graphs and vectors). One or more nodes may remain in the free state.

Canopy clustering is an unsupervised pre-clustering algorithm associated with the k-means algorithm. Canopy clustering is a method used to speed up clustering operations of large datasets, where using another algorithm directly may be impractical due to the size of the data set. Canopy clustering processes a given dataset and provides an approximation of the number of clusters and the initial cluster centroids of the given dataset. The steps to perform canopy clustering, using two thresholds T₁ (i.e., the loose distance) and T₂ (i.e., the tight distance), where T₁>T₂, include: first, specifying threshold distances T₁ and T₂; second, specifying the set of data points to be clustered; third, removing a first point from the set of data points to begin a new ‘canopy’ containing the first point; fourth, for each point left in the set of data points, assigning each point to a new canopy if its distance to the first point of the canopy is less than threshold distance T₁; fifth, removing any point from the set of data points if the distance of the point is also less than threshold distance T₂; and sixth, repeating the prior steps (i.e., beginning at the second step) until there are no remaining data points in the set of data points to be clustered.

k-means algorithm is used for solving the problem of clustering when the dataset is unlabeled (i.e., the dataset is without defined categories or groups). The main notion of the k-means algorithm is how to select the best value of “k.” There are two modes in which the k-means algorithm can be applied: the serial mode and the parallel mode. In the serial mode, the k-means algorithm is implemented in a single machine. There are two categories of the parallel mode—a data-parallel category and a control-parallel category. In the data-parallel category, the dataset is divided into smaller datasets, and similar computing is conducted on each dataset. The data-parallel category is executed on a personal computer with multiple threads or on a set of computers that are connected. In the control-parallel category, different computing is conducted on smaller datasets.

In step 240, when a node is judged to be a subordinate of the same cluster, program 122 organizes the node into a miniature graph. In an embodiment, responsive to performing a preliminary clustering of the nodes, program 122 organizes the node into a miniature graph (i.e., a data structure). A node (i.e., the type of node) is judged to be a subordinate of the same cluster when the algorithm determines the node belongs to the same cluster. In an embodiment, program 122 calculates a degree of similarity between the miniature graph as a unit and a second node (e.g., as shown in FIG. 3G). In an embodiment, program 122 assigns a clustering relationship to the miniature graph as a unit and the second node using link prediction (e.g., node-similarity method, e.g., as shown in FIG. 3H). Link prediction predicts the existence of a link between a pair of nodes (i.e., two nodes) based on the similarity of attributes of the nodes using an algorithm. Examples of link prediction include predicting which customers are likely to buy a product on an online marketplace, predicting friendship links among users in a social network, predicting interactions or collaborations between employees in an organization, predicting co-authorship links in a citation network, and predicting interactions between genes and proteins in a biological network. The degree of similarity between the node represented in the miniature graph as a unit and the second node is not calculated. Rather, the context embedding of the graph is calculated. In an embodiment, program 122 repeats the calculation of the degree of similarity and the assignment of the clustering relationship to the certain cluster (i.e., an assignment of a vector to a certain cluster) until each node is assigned to a certain cluster.

In step 245, program 122 stores the clustering relationships in a database. In an embodiment, responsive to organizing the node into the miniature graph, program 122 stores the clustering relationships in a database (e.g., database 124). The process ends when all vectors have been grouped into an appropriate cluster and stored in the database.

FIG. 3A is an exemplary diagram illustrating a filtering of the tags of the plurality of external classification models, on server 120 within distributed data processing environment 100 of FIG. 1, in accordance with an embodiment of the present invention. Program 122 filters the tags of the plurality of external classification models (e.g., 3A-100) based on a pre-set confidence score, wherein the pre-set confidence score is a pre-set threshold based on a deep learning model. Program 122 filters (e.g., 3A-200) the tags of the plurality of external classification models to remove any tags that are irrelevant to the one or more sentences of the set of text. A tag is determined to be irrelevant to the one or more sentences of the set of text when the tag provided by the external classification model does not exceed a confidence score of 0.5. Program 122 retains the tags with a confidence score greater than 0.5 and any associated tags (e.g., 3A-300). Program 122 removes the tags with a confidence score less than 0.5 and the associated tags.

FIG. 3B is an exemplary diagram illustrating a forming of a node in a graph structure, on server 120 within distributed data processing environment 100 of FIG. 1, in accordance with an embodiment of the present invention. Program 122 represents each sentence of the set of text (e.g., 3B-100) as a node (e.g., 3B-200) in a graph structure. Program 122 represents each of the tags associated with each sentence of the set of text as attributes (e.g., 3B-300) of the node in the graph structure

FIG. 3C is an exemplary diagram illustrating a creation of a cluster, on server 120 within distributed data processing environment 100 of FIG. 1, in accordance with an embodiment of the present invention. Program 122 receives a first set of text (e.g., 3C-100), designated Sentence A, from a user which reads, “The month of April is the best time to view the flowers in the Tokyo area. However, the month of April can also be very perilous. In addition to the cherry blossom petals scattered about, the influenza virus is spreading.” Program 122 categorizes Sentence A as “news” and tags Sentence A as “social news” (3C-200). Program 122 receives a second set of text (e.g., 3C-300), designated Sentence B, from the user which reads, “The Tokyo Olympics in Japan is facing many crises, and the new crown pneumonia is not the only threat. Some experts point out that “suspending” is the only option.” Sentence B is very similar to Sentence A based on semantics. Program 122 categorizes Sentence B as “news,” but labels Sentence B as “sports news” or “international news” (e.g., 3C-400) to give it a certain degree of difference in the following clustering step. Program 122 represents each sentence as a node in a graph structure and each of the tags associated with each sentence as attributes of the node in the graph structure. In an embodiment, program 122 clusters (e.g., 3C-500) the nodes of Sentence A and Sentence B together based on the similarities between the sentences.

FIG. 3D is an exemplary diagram illustrating an aggregation of a plurality of clusters into a plurality of similar categories, on server 120 within distributed data processing environment 100 of FIG. 1, in accordance with an embodiment of the present invention. Program 122 preliminarily clusters (e.g., 3D-100) a plurality of the nodes (e.g., 3D-200) of the one or more sentences in the set of text. Program 122 aggregates the clusters into multiple similar categories.

FIG. 3E is an exemplary diagram illustrating an embedding of each sentence of the set of text and the tags associated with each sentence of the set of text, on server 120 within distributed data processing environment 100 of FIG. 1, in accordance with an embodiment of the present invention. Program 122 receives a set of text. Program 122 tags each sentence (e.g., 3E-100) of the set of text (i.e., each category of the one or more categories) with one or more tags (e.g., 3E-200) using the plurality of external classification models. Program 122 embeds each sentence of the set of text and the tags associated with each sentence of the set of text using a one hot encoding method (e.g., 3E-300). Program 122 produces a fully connected network (i.e., a category of neural networks, e.g., 3E-400). Program 122 vectorizes the contents of the node (i.e., the sentence and the tags associated with the sentence, i.e., a fusion vector, e.g., 3E-500). Program 122 performs a preliminary clustering of the nodes. Program 122 enables a small part of the overall node to organize each other to form a settlement.

FIG. 3F is an exemplary diagram illustrating a preliminary clustering of one or more nodes, on server 120 within distributed data processing environment 100 of FIG. 1, in accordance with an embodiment of the present invention. Program 122 performs a preliminary clustering of the nodes (e.g., 3F-100_{1-N}) under strict conditions using canopy clustering.

FIG. 3G is an exemplary diagram illustrating a determination of subordinates of similar clusters, on server 120 within distributed data processing environment 100 of FIG. 1, in accordance with an embodiment of the present invention. Program 122 determines whether a node (i.e., the type of node) is a subordinate of a cluster. When a node is determined to be a subordinate of a cluster, program 122 organizes the node into a miniature graph. Program 122 calculates a degree of similarity between the miniature graph as a unit (e.g., 3G-100) and a second node (e.g., 3G-200). In other words, program 122 calculates whether an isolated node belongs to a graph cluster.

FIG. 3H is an exemplary diagram illustrating an assignment of a clustering relationship using link prediction, on server 120 within distributed data processing environment 100 of FIG. 1, in accordance with an embodiment of the present invention. Program 122 assigns a clustering relationship to the miniature graph as a unit (e.g., 3H-100) and the second node (e.g., 3H-200) using link prediction (e.g., node-similarity method).

FIG. 4 is a block diagram illustrating the components of computing device 400 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made. Computing device 400 includes processor(s) 404, memory 406, cache 416, communications fabric 402, persistent storage 408, input/output (I/O) interface(s) 412, and communications unit 410. Communications fabric 402 provides communications between memory 406, cache 416, persistent storage 408, input/output (I/O) interface(s) 412, and communications unit 410. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a cross switch. Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of computer processor(s) 404 by holding recently accessed data, and data near accessed data, from memory 406.

Program instructions and data (e.g., software and data 414) used to practice embodiments of the present invention may be stored in persistent storage 408 and in memory 406 for execution by one or more of the respective processor(s) 404 via cache 416. In an embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408. Software and data 414 can be stored in persistent storage 408 for access and/or execution by one or more of the respective processor(s) 404 via cache 416. With respect to user computing device 130, software and data 414 includes user interface 132. With respect to server 120, software and data 414 includes long text clustering program 122.

Communications unit 410, in these examples, provides for communications with other data processing systems or devices. In these examples, communications unit 410 includes one or more network interface cards. Communications unit 410 may provide communications through the use of either or both physical and wireless communications links. Program instructions and data (e.g., software and data 414) used to practice embodiments of the present invention may be downloaded to persistent storage 408 through communications unit 410.

I/O interface(s) 412 allows for input and output of data with other devices that may be connected to each computer system. For example, I/O interface(s) 412 may provide a connection to external device(s) 418, such as a keyboard, a keypad, a touch screen, and/or some other suitable input device. External device(s) 418 can also include portable computer readable storage media, such as, for example, thumb drives, portable optical or magnetic disks, and memory cards. Program instructions and data (e.g., software and data 414) used to practice embodiments of the present invention can be stored on such portable computer readable storage media and can be loaded onto persistent storage 408 via I/O interface(s) 412. I/O interface(s) 412 also connect to display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

While particular embodiments of the present invention have been shown and described here, it will be understood to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understand, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “at least one” or “one or more” and indefinite articles such as “a” or “an”, the same holds true for the use in the claims of definite articles.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart illustrations and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart illustrations and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart illustrations and/or block diagram block or blocks.

The flowchart illustrations and block diagrams in the Figures illustrate the architecture, functionality, and operation of possible implementations of systems, methods, and computer program products according to various embodiments of the present invention. In this regard, each block in the flowchart illustrations or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each flowchart illustration and/or block of the block diagrams, and combinations of flowchart illustration and/or blocks in the block diagrams, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving, by one or more processors, a set of text, wherein the set of text contains one or more sentences;
tagging, by the one or more processors, each sentence of the set of text with one or more tags using a plurality of open-source text classification models; and
performing, by the one or more processors, a preliminary clustering of one or more nodes under strict conditions using a canopy clustering algorithm.

2. The computer-implemented method of claim 1, wherein receiving the set of text further comprises:
dividing, by the one or more processors, each sentence of the set of text into one or more categories, wherein each category of the one or more categories represents a grouping regarded as having a particular shared characteristic.

3. The computer-implemented method of claim 1, further comprising:
subsequent to tagging each sentence of the set of text with the one or more tags using the plurality of open-source text classification models, filtering, by the one or more processors, the one or more tags using a confidence score;
retaining, by the one or more processors, each tag of the one or more tags with a confidence score greater than 0.5; and
removing, by the one or more processors, each tag of the one or more tags with a confidence score less than 0.5.

4. The computer-implemented method of claim 3, further comprising:
subsequent to filtering the one or more tags using the confidence score, representing, by the one or more processors, each sentence of the set of text as a first node in a graph structure; and
representing, by the one or more processors, each tag of the one or more tags as an attribute of the first node in the graph structure.

5. The computer implemented method of claim 4, further comprising:
subsequent to representing each tag of the one or more tags as an attribute of the first node in the graph structure, embedding, by the one or more processors, each sentence and each tag of the first node using a one-hot encoding method; and
vectorizing, by the one or more processors, each sentence and each tag of the first node.

6. The computer implemented method of claim 1, wherein performing the preliminary clustering of the one or more nodes under strict conditions using the canopy clustering algorithm further comprises:
enabling, by the one or more processors, a part of the one or more nodes to organize to form a settlement.

7. The computer-implemented method of claim 1, further comprising:
determining, by the one or more processors, the first node is a subordinate of a cluster using an algorithm;
organizing, by the one or more processors, the first node into a miniature graph;
calculating, by the one or more processors, a degree of similarity between the miniature graph and a second node; and
assigning, by the one or more processors, a clustering relationship to the miniature graph and the second node using link prediction.

8. A computer program product comprising:
one or more computer readable storage media and program instructions stored on the one or more computer readable storage media, the program instructions comprising:
program instructions to receive a set of text, wherein the set of text contains one or more sentences;
program instructions to tag each sentence of the set of text with one or more tags using a plurality of open-source text classification models; and
program instructions to perform a preliminary clustering of one or more nodes under strict conditions using a canopy clustering algorithm.

9. The computer program product of claim 8, wherein receiving the set of text further comprises:
program instructions to divide each sentence of the set of text into one or more categories, wherein each category of the one or more categories represents a grouping regarded as having a particular shared characteristic.

10. The computer program product of claim 8, further comprising:
subsequent to tagging each sentence of the set of text with the one or more tags using the plurality of open-source text classification models, program instructions to filter the one or more tags using a confidence score;
program instructions to retain each tag of the one or more tags with a confidence score greater than 0.5; and
program instructions to remove each tag of the one or more tags with a confidence score less than 0.5.

11. The computer program product of claim 10, further comprising:
subsequent to filtering the one or more tags using the confidence score, program instructions to represent each sentence of the set of text as a first node in a graph structure; and
program instructions to represent each tag of the one or more tags as an attribute of the first node in the graph structure.

12. The computer program product of claim 11, further comprising:
subsequent to representing each tag of the one or more tags as an attribute of the first node in the graph structure, program instructions to embed each sentence and each tag of the first node using a one-hot encoding method; and
program instructions to vectorize each sentence and each tag of the first node.

13. The computer program product of claim 8, wherein performing the preliminary clustering of the one or more nodes under strict conditions using the canopy clustering algorithm further comprises:
program instructions to enable a part of the one or more nodes to organize to form a settlement.

14. The computer program product of claim 8, further comprising:
program instructions to determine the first node is a subordinate of a cluster using an algorithm;
program instructions to organize the first node into a miniature graph;
program instructions to calculate a degree of similarity between the miniature graph and a second node; and
program instructions to assign a clustering relationship to the miniature graph and the second node using link prediction.

15. A computer system comprising:
one or more computer processors;
one or more computer readable storage media;
program instructions collectively stored on the one or more computer readable storage media for execution by at least one of the one or more computer processors, the stored program instructions comprising:
program instructions to receive a set of text, wherein the set of text contains one or more sentences;
program instructions to tag each sentence of the set of text with one or more tags using a plurality of open-source text classification models; and
program instructions to perform a preliminary clustering of one or more nodes under strict conditions using a canopy clustering algorithm.

16. The computer system of claim 15, wherein receiving the set of text further comprises:
program instructions to divide each sentence of the set of text into one or more categories, wherein each category of the one or more categories represents a grouping regarded as having a particular shared characteristic.

17. The computer system of claim 15, further comprising:
subsequent to tagging each sentence of the set of text with the one or more tags using the plurality of open-source text classification models, program instructions to filter the one or more tags using a confidence score;
program instructions to retain each tag of the one or more tags with a confidence score greater than 0.5; and
program instructions to remove each tag of the one or more tags with a confidence score less than 0.5.

18. The computer system of claim 17, further comprising:
subsequent to filtering the one or more tags using the confidence score, program instructions to represent each sentence of the set of text as a first node in a graph structure; and
program instructions to represent each tag of the one or more tags as an attribute of the first node in the graph structure.

19. The computer system of claim 18, further comprising:
subsequent to representing each tag of the one or more tags as an attribute of the first node in the graph structure, program instructions to embed each sentence and each tag of the first node using a one-hot encoding method; and
program instructions to vectorize each sentence and each tag of the first node.

20. The computer system of claim 15, further comprising:
program instructions to determine the first node is a subordinate of a cluster using an algorithm;
program instructions to organize the first node into a miniature graph;
program instructions to calculate a degree of similarity between the miniature graph and a second node; and
program instructions to assign a clustering relationship to the miniature graph and the second node using link prediction.
